(19) United States
(12) Patent Application Publication
(10) Pub. No.: US 2006/0146042 A1
(43) Pub. Date: Jul. 6, 2006

(54) Selective addressing capable display

(75) Inventors: Krishnan Ravichandran, Saratoga, CA (US); David B. Chung, Cupertino, CA (US)

Correspondence Address: DAVID N TRAN;INTEL CORPORATION SC4-202, 2200 MISSION COLLEGE BLVD, SANTA CLARA, CA, 95052, US

(73) Assignee: Intel Corporation

(21) Appl. No.: 11/027,628

(22) Filed: Dec. 30, 2004

(51) Int. Cl. G09G 5/00

(52) U.S. Cl. 345/211

(57) ABSTRACT

An organic light-emitting diode (OLED) display is used in a system having a display controller that includes logic allowing a display area to be reduced from one size to a smaller size, according to one embodiment. The display area is reduced in response to a charge level of a battery decreasing to a predetermined level.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates generally to the field of power management. More specifically, the present invention relates to power management associated with displays.

### BACKGROUND

As more functionality is integrated into modern computer systems, the need to reduce power consumption becomes increasingly important, especially when the computer systems are mobile systems that operate on battery power. Users of mobile systems continuously expect longer battery life. Mobile system designers try to address the need for longer battery life by implementing power management solutions that include reducing clock speeds of processor, reducing clock speeds of chipset, and disabling unused components

### BRIEF DESCRIPTION OF THE DRAWINGS

The present invention is illustrated by way of example, and not limitation, in the figures of the accompanying drawings in which like references indicate similar elements and in which:

FIG. 1 is a block diagram illustrating an example of a computer system that may be used in accordance with an embodiment of the invention.

FIG. 2 illustrates an example of a display area on a liquid crystal display (LCD).

FIG. 3A illustrates an example of a display area on a display having pixels with brightness that may be individually controlled, in accordance with one embodiment.

FIG. 3B illustrates another example of a display area on an OLED display, in accordance with one embodiment.

FIG. 3C illustrates an example of multiple display areas on an OLED display, in accordance with one embodiment.

FIG. 4 illustrates an example of a system with two display controllers and an OLED display, in accordance with one embodiment.

FIG. 5 is a flow diagram illustrating an example of a process performed by a display controller with an OLED display, according to one embodiment.

### DETAILED DESCRIPTION

For one embodiment, a method to reduce power consumption of a computer system having an organic light emitting diode (OLED) display is disclosed. The reduction of power consumption may be performed by transitioning a display area from one display size to another display size.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

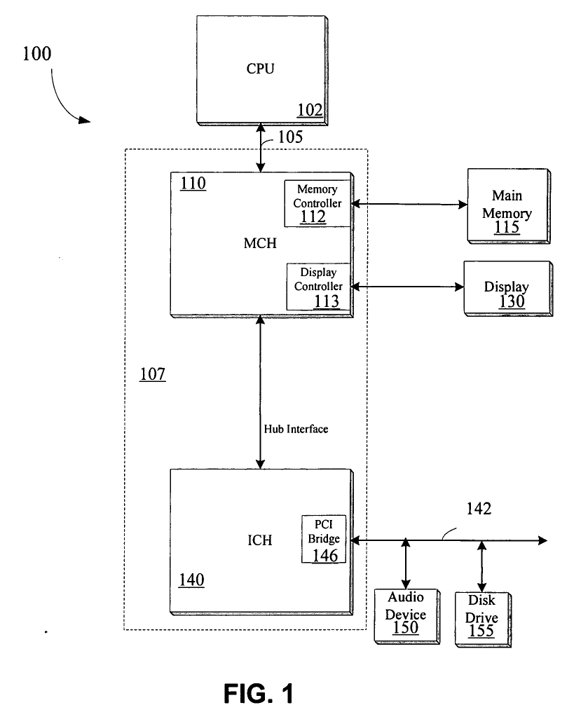

FIG. 1 is a block diagram illustrating an example of a computer system that may be used in accordance with an embodiment of the invention. Computer system 100 may include a central processing unit (CPU) or processor 102 and may receive its power from an electrical outlet or a battery. The CPU 102 may be coupled to a bus 105. The CPU 102 may be manufactured by, for example, Intel Corporation of Santa Clara, Calif., although it may also be manufactured by other companies.

Chipset 107 may be coupled to the bus 105. The chipset 107 may include a memory control hub (MCH) 110. The MCH 110 may include a memory controller 112 that is coupled to system memory 115 (e.g., random access memory (RAM), read-only memory (ROM), etc.). The system memory 115 may store data and sequences of instructions that are executed by the CPU 102 or any other processing devices included in the computer system 100. For example, in addition to the CPU 102, the computer system 100 may include a secondary CPU or controller (not shown).

The MCH 110 may include a display controller 113. A display 130 may be coupled to the display controller 113. The display 130 may be a liquid crystal display (LCD) which is commonly used in devices such as flat panel displays for laptop computers, personal digital assistants, cellular phones, and the like. LCDs frequently use a cold cathode fluorescent lamp (CCFL) or similar devices as a backlight. The CCFLs may consume large quantities of power.

Some manufacturers recently use OLED materials as a backlight source. OLED is a technology developed by the Eastman Kodak Company of Rochester, N.Y. OLEDs are thin film materials which emit light when excited by electric current. Since OLEDs emit light of different colors, they are be used to make displays. Displays made from OLED materials, therefore, do not need additional backlights, thus eliminating the need for the CCFL. OLED displays are usually lightweight and may operate efficiently at relatively low voltages, thus consuming less power from the system. For one embodiment, the display 130 may be an OLED display or a display that includes picture elements (pixels) having brightness individually controllable.

The chipset 107 may also include an input/output control hub (ICH) 140. The ICH 140 is coupled with the MCH 110 via a hub interface. The ICH 140 provides an interface to input/output (I/O) devices within the computer system 100. The ICH 140 may be coupled to a peripheral bus (e.g., Peripheral Component Interconnect (PCI) bus). Thus, the ICH 140 may include a PCI bridge 146 that provides an interface to a PCI bus 142. The PCI bridge 146 may provide a data path between the CPU 102 and peripheral devices. An audio device 150 and a disk drive 155 may be connected to the PCI bus 142. For wireless communication, an antenna (not shown) may also be coupled to the PCI bus 142. Although not shown, other devices (e.g., keyboard, mouse, etc.) may also be connected to the PCI bus 142. The computer system 100 may use a direct current (DC) power source such as, for example, a battery. Alternatively, it may use an alternating current (AC) power source by, for example, plugging into an electrical connector. The computer system 100 may consume the most power when it is in a normal power mode. The computer system 100 may consume less power when it is in a low power mode (e.g., suspend or standby mode), which may be important when a DC power source is used.

Display Area

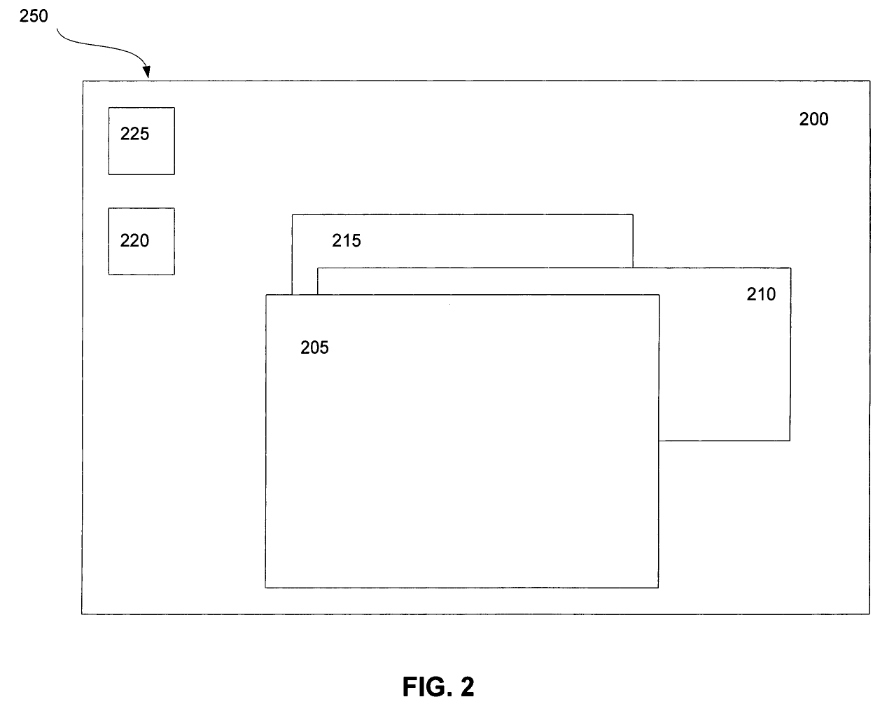

FIG. 2 illustrates an example of a display area on a LCD. For one embodiment, the computer system 100 may be configured to operate with an operating system (OS) that includes a window user interface such as, for example, Microsoft Windows XP manufactured by Microsoft (MS) Corporation of Redmond, Wash. In this example, display 250 may be a LCD, and the window user interface may use a display area 200 that occupies the entire display screen of the display 250. When using the Window XP OS, this display area 200 may be referred to as a desktop. The display area 200 may include multiple open windows 205, 210, and 215. The display area 200 may include icons relating to applications, folders, etc. such as, for example, icon 225 and folder 220. Although not shown, the display area 200 may also include other information.

It may be noted that the display 250 may also be an OLED display. That is, the display 250 may include pixels that emit light (self-luminous pixels) when an electric current passes through them. There may be no requirement to have a backlight, as may be required when the display 250 is a LCD. Furthermore, because the current passing through each of the pixels of the display 250 may be controlled, each pixel may emit light independently of the others. This may be advantageous because the power consumption may occur mostly by the pixels that are turned on (i.e., emit light). Those pixels that are turned off (i.e., not emit light) may not consume any power. In the example when the display 250 is an OLED display, the display controller 113 would still output or turn on all of the pixels enabling the display area 200 to occupy the entire display screen. The properties of pixels in an OLED display are known to one skilled in the art.

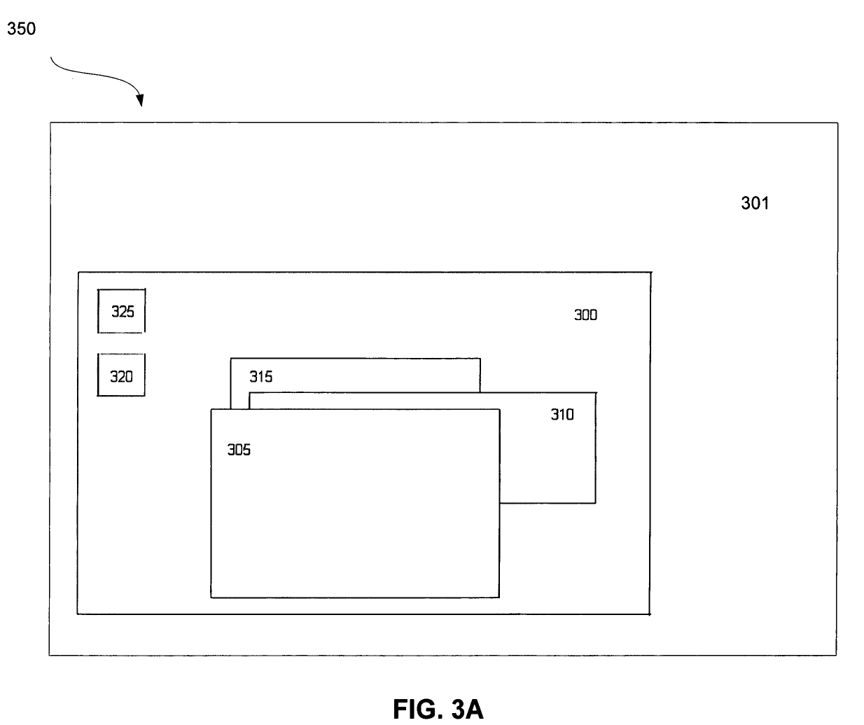

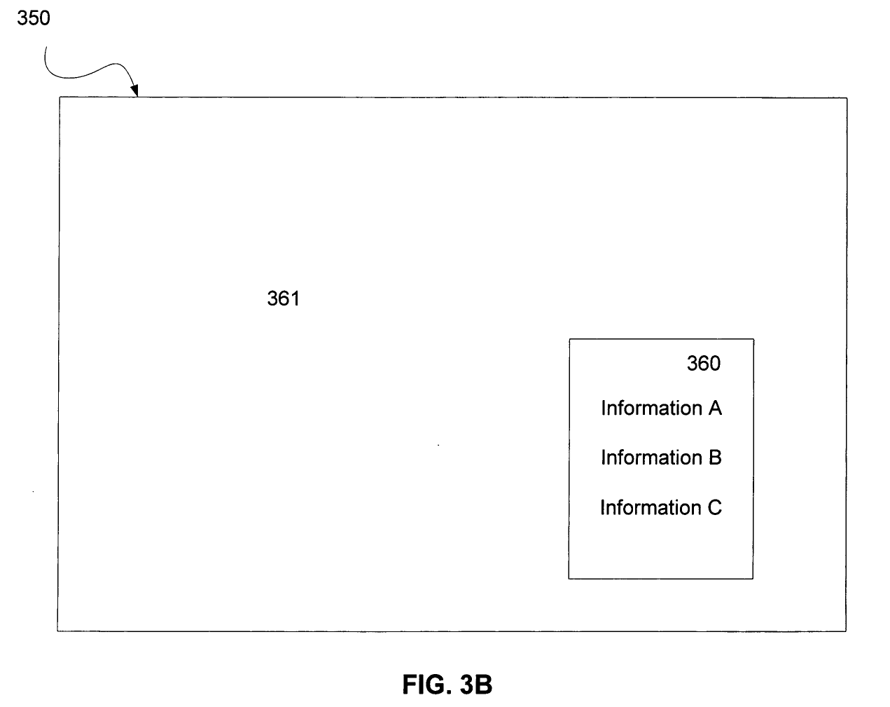

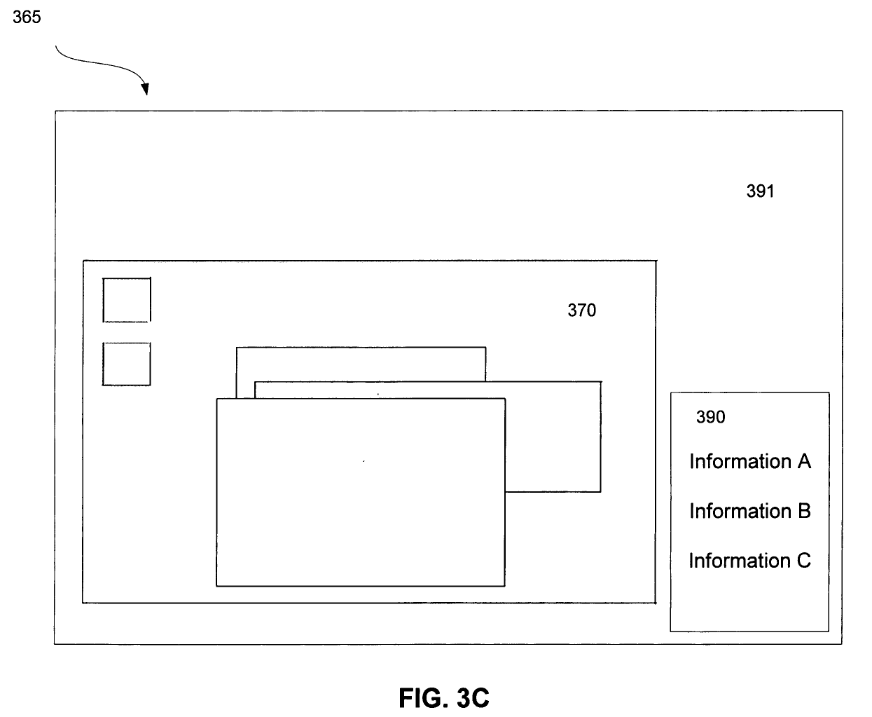

FIG. 3A illustrates an example of a display area on a display having pixels with brightness that may be individually controlled, in accordance with one embodiment. Display 350 may be an OLED display. For one embodiment, to reduce power consumption associated with the display 350, the size of a display area may be reduced. This reduction may be from a size that occupies the entire display screen as the display area 200. This is illustrated as the display area 300 in FIG. 3A. For one embodiment, the display controller 113 may include logic to limit displaying information to only within the display area 300. The information (or display content) may be limited or shrunk to fit in a smaller display area using different techniques. For one embodiment, display content may be passed through a scaling logic in the display controller 113 that transforms the pixels by multiplying with a fraction and discarding any fractional values. For example, when display controller 113 reduces a display area from a full size to one that is one quarter of the full size, the rows and columns may each be multiplied by 0.5 and a pixel at, for example, row 500 and column 600 in the full size display area may be transferred to row 250 and column 300 in the quarter size display area.

For another embodiment, the transformation may be performed in software using, for example, video driver and the Operating System (OS), such that the display content may be reduced with little loss of readability. For example, the OS may have a ‘simple’ mode where a lot of the graphic details on icons, tool bars etc may be eliminated to save space. The OS may have an entirely new user-interface mode that can be switched to accommodate smaller display areas as those typically used in cell phones, personal digital assistants (PDA), etc. The interface protocol between the display controller 113 and the display 350 (e.g., the Low Voltage Differential Signaling (LVDS) interface) may also be enhanced to support such modes. For example, the display controller 113 may send only data for a fraction of the screen and the display 350 may fill in the rest of the areas with black (pixels turned off). Power may be saved on the interface also by not having to send a lot of black pixels. The new interface may default all pixels to black unless data is sent for that pixel. Referring to the example in FIG. 3A, the pixels associated with the display area 300 may be configured to emit light or turned on, and the pixels associated with area 301 may be configured to not emit light or turned off. It may be noted that reducing the size of a display area may not be necessary when the computer system 100 is using the AC power source.

Power Monitoring Logic

For one embodiment, a power monitoring logic (not shown) may be used to monitor a current charge level of a DC power source (e.g., battery) that is used to provide power to the computer system 100. The power monitoring logic may be coupled to the display controller 113. The power monitoring logic may be implemented in software, hardware or a combination of both software and hardware.

The power monitoring logic may generate a signal when the current charge level of the battery decreases to a certain predetermined level. There may be multiple predetermined levels. The signal may be sent to the display controller 113 and may indicate that reducing the current size of the display area may be necessary. For example, when the current charge level of the battery is at 50% of its full capacity, the display area may be reduced from its normal full size. When the battery capacity is at 15% of its full capacity, the display area may be further reduced from a current size. For one embodiment, when the computer system 100 is powered on, and the power monitoring logic detects that a battery power source is being used but the battery is at less than its full capacity, a reduced display area (e.g., display area 300) may be used to display information.

For one embodiment, the power monitoring logic may also generate a signal when the computer system 100 switches from a DC power source to an AC power source. When this signal is received by the display controller 113, the size of the display area may be restored to its normal full size. This full size may be a largest size possible with the display 350. Alternatively, this full size may be a size previously specified even though it may not be a largest size possible with the display 350.

Displayed Information

For one embodiment, the information included in a display area may be the same even though the display area may have different sizes. For example, the information included in the display area 300 may be similar to the information included in the display area 200 illustrated in FIG. 2. For one embodiment, the information displayed in the display area 300 may be in higher resolution. For example, any textual information may be displayed in smaller fonts, and any images may be displayed in smaller sizes. It may be noted in the current example that the small display area 300 has the same number of open windows (e.g., windows 305, 310 and 315) as the large display area 200 illustrated in FIG. 2.

FIG. 3B illustrates another example of a display area on a display having pixels with brightness that may be individually controlled, in accordance with one embodiment. For one embodiment, when the size of a display area is reduced, the information included in the reduced display area may be limited. For example, the reduced display area may include a subset of the information included in a display area having a larger size. Any textual information may be displayed in smaller fonts or in the same fonts. Images may be displayed in smaller sizes or may even be omitted. One example of displaying a subset of the information is illustrated in the display area 360 in FIG. 3B. In this example, the display area 360 is illustrated to include some but not all of the information included in the display area 200 or the display area 300. It may be noted that the examples above assume that the information remain static. It may be possible that the information displayed in the display area 360 may be completely different from the information displayed in the display area 200 or in the display area 300.

Pixels associated with the display area 360 may be turned on, and pixels associated with the area 361 may be turned off. For one embodiment, the display area 360 may be used when the computer system 100 is in the suspend or standby mode. For example, the information displayed in the display area 360 may be limited to information that is sufficient for quick reference for on the go situations including calendar appointments, email headers, reminders, to do list, etc.

Multiple Display Areas

FIG. 3C illustrates an example of multiple display areas on a display having pixels with brightness that may be individually controlled, in accordance with one embodiment. Display 365 may be an OLED display. For one embodiment, the display 365 may include two display areas 370 and 390. Pixels associated with each of the display areas 370 and 390 may be turned on, while pixels associated with the remaining area 391 may be turned off. The display area 370 may be used to display information associated with applications (e.g., MS Word for Windows XP, MS Outlook for Windows XP, etc.) that are normally used with a desktop or a laptop computer systems. The display area 390 may be used to display information associated with applications that are normally used with handheld computer systems (e.g., personal digital assistants (PDA), etc.), or those computer systems that typically have small displays.

For one embodiment, information displayed in the two display areas 370 and 390 may be controlled by two different graphics controllers. For example, the display area 370 may be associated with the display controller 113, and the display area 390 may be associated with a secondary display controller (not shown). For one embodiment, all of the multiple display areas (e.g., display areas 370 and 390) may be visible on the OLED display at the same time. Alternatively, there may only be one display area (e.g., display area 370 or display area 390) visible at a time. For one embodiment, the secondary display controller may be a low power graphics controller. The secondary display controller may be active when the computer system 100 is in the suspend/standby mode or when the charge level of the DC power source is low. The secondary display controller may allow the computer system 100 to be in a low power consumption state while still making some information in the computer system 100 available.

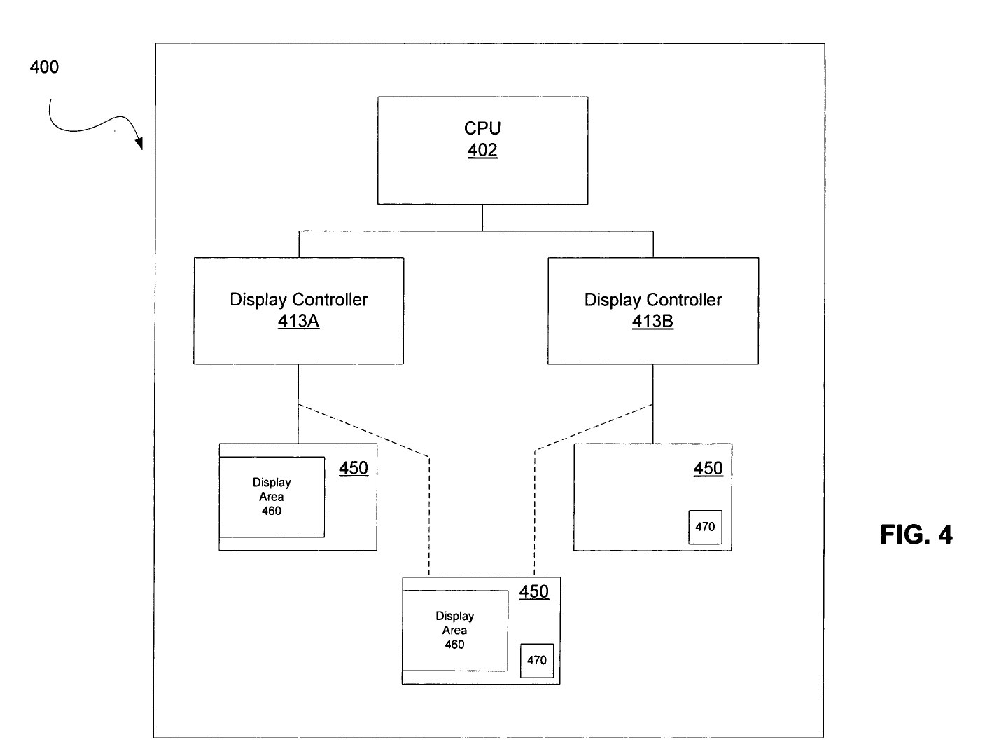

FIG. 4 illustrates an example of a system with a two display controllers and OLED display, in accordance with one embodiment. Computer system 400 may include CPU 402. Coupled with the CPU 102 may be a primary display controller 413A and a secondary display controller 413B. Both of the display controllers 413A and 413B may be able to access information in the same memory (not shown) and may control information displayed on the OLED display 450. The display controller 413A may be limited to displaying information within the display area 460. The display controller 413B may be limited to displaying information within the display area 470. The display controller 413B may consume less power than the display controller 413A and may be active while the display controller 413A is active. Alternatively, the display controller 413B may be active when the display controller 413A is not. Being active may include being in a power state that consumes more power than not being active. As illustrated, the display areas 460 and 470 may be both visible on the display 450 at the same time, or each one may only be visible at a time, depending on whether the computer system 400 is in a normal power mode or in a low power mode.

Display Process

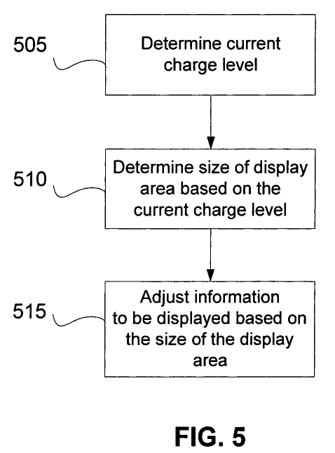

FIG. 5 is a flow diagram illustrating an example of a process performed by a display controller with an OLED display, in accordance with one embodiment. This process may be performed by a system operating with a DC power source such as a battery and having one or more display controllers. At block 505, a current charge level of a battery is determined. When the current charge level is at or near a predetermined charged level, the display controller may limit displaying its information to within a smaller display area. This may include determining the size of a new display area based on the current charge level, as shown in block 510. At block 515, the information to be displayed within the new display area is adjusted accordingly. This may include, for example, displaying textual information in smaller fonts. This may also include displaying a subset of the original information in the new display area.

Although the examples described above includes rectangle display areas, it may be possible for the display controller to set the display area to be in different forms such as, for example, circle, triangle, etc. The display controller may also set the display area in different locations. Furthermore, although the descriptions refer to the OLED displays, one skilled in the art will recognize that other displays implemented with display technologies that allow pixels to be individually controlled, including controlling the brightness of each pixel, may also be used.

The operations of the various techniques described above may be implemented as sequences of computer program instructions that are stored in a memory which may be considered to be a machine-readable storage media. The memory may be RAM, ROM, a persistent storage memory, such as mass storage device or any combination of these devices. The instructions may be loaded into memory of the computer system from a storage device or from one or more other computer systems (e.g. a server computer system) over a network connection. The instructions may be stored concurrently in several storage devices (e.g. RAM and a hard disk, such as virtual memory). Consequently, the execution of these instructions may be performed directly by a processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement embodiments of the present invention. Thus, the present invention is not limited to any specific combination of hardware circuitry and software, or to any particular source for the instructions executed by the computer system.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method, comprising:
reducing a display area of a display from a first size to a second size when a charge level of a direct current (DC) power source reaches a predetermined level, wherein the display is to include pixels that can be individually configured to emit light.

2. The method of claim 1, wherein the display is an organic light emitting diode (OLED) display.

3. The method of claim 2, wherein pixels associated with the display area having the second size are configured to emit light.

4. The method of claim 3, wherein pixels not associated with the display area having the second size are configured to not emit light.

5. The method of claim 4, further comprising:
transforming display content in the display area having the first size to be displayed in the display area having the second size

6. The method of claim 4, further comprising:
displaying information within the display area having the second size in high resolution.

7. The method of claim 4, wherein display content associated with the display area having the second size is a subset of display content associated with the display area having the first size.

8. The method of claim 7, further comprising:
using a first user interface with the display area having the first size; and
using a second user interface with the display area having the second size.

9. The method of claim 8, wherein a default setting is used for pixels not associated with the display area having the second size, and wherein the default setting includes not turning on these pixels.

10. A system, comprising:
a processor;
a display coupled to the processor and include pixels that can be individually configured to emit light;
a direct current (DC) power source coupled to the processor and to the display;
a first display controller coupled to the display, the first display controller is to control information displayed within a first display area of the display; and
a second display controller coupled to the display, the second display controller is to control information displayed within a second display area of the display.

11. The system of claim 10, wherein the display is an organic light emitting diode (OLED) display.

12. The system of claim 10, wherein one or more of the first display controller and the second display controller is active at a time.

13. The system of claim 12, wherein the second display controller consumes less power than the first display controller.

14. The system of claim 13, wherein the second display controller is active when a charge level of the DC power source decreases to a predetermined level.

15. The system of claim 10, wherein pixels associated with the first display area and pixels associated with the second display area are configured to emit light.

16. The system of claim 15, wherein pixels not associated with one or more of the first display area and the second display area are configured to not emit light.

17. An article of manufacture comprising:
a machine readable medium that provides instructions that, if executed by a machine, will cause the machine to perform operations including:
receiving a signal to indicate a charge level of a direct current (DC) power source decreasing to a predetermined level;
reducing a display area of a display from a first size to a second size; and
configuring pixels associated with the display area having the second size to emit light.

18. The article of claim 17, wherein the display is an organic light emitting diode (OLED) display.

19. The article of claim 18, wherein pixels associated with the display area having the second size are configured to not emit light.

20. The article of claim 19, wherein reducing the display area from the first size to the second size comprises:
transforming display content from the display area having the first size to the display area having the second size.

21. A system, comprising:
a processor;
a display controller coupled to the processor, the display controller including logic to change a display area from a first size to a second size;
a display coupled to the display controller, the display including pixels that can be individually configured to emit light; and
an antenna coupled to the processor.

22. The system of claim 21, further comprising:
a direct current (DC) power source coupled to the processor and the display;
a power monitoring logic coupled to the DC power source, the power monitoring logic generating a signal when a charge level of the DC power source decreases to a predetermined level.

23. The system of claim 22, wherein responsive to receiving the signal, the display controller changes the display area from the first size to the second size.

24. The system of claim 23, wherein responsive to receiving the signal, the display controller further configure pixels within the display area having the second size to emit light and pixels not within the display area having the second size not to emit light.
